(19) United States
(12) Patent Application Publication
(10) Pub. No.: US 2011/0118782 A1
(43) Pub. Date: May 19, 2011

(54) Infant Teething Device

(76) Inventor: Stacy Kashey, Northfield, NJ (US)

(21) Appl. No.: 12/947,072

(22) Filed: Nov. 16, 2010

Related U.S. Application Data
(60) Provisional application No. 61/262,581, filed on Nov. 19, 2009.

(51) Int. Cl. A61J 17/00

(52) U.S. Cl. 606/235

(57) ABSTRACT

A liquid-fillable teething device fabricated in the shape of a letter of the alphabet, wherein the liquid-fillable teething device has at least one non-smooth textured surface thereon is provided.

This application claims benefit of priority to U.S. Provisional Application Ser. No. 61/262,581, filed Nov. 19, 2009, the contents of which is herein incorporated by reference in its entirety.

### BACKGROUND OF THE INVENTION

Infants universally enjoy sucking and chewing on various “oral devices,” including pacifiers and teething products designed to provide an infant relief from the pain and itching of cutting teeth. Pacifiers and teething devices are manufactured and sold as small, individual items. Various types of pacifiers and teething elements have been described.

U.S. Pat. Nos. D331,783; D335,928; D472,320; 699,757; 2,699,785; 3,267,937; 3,556,104; 3,669,117 6,063,107; and 6,461,214 disclose pacifiers and teething products with handles. U.S. Pat. Nos. 6,292,962; 5,344,355; 4,188,747; and 6,666,740; and DE19839904 and GB2388041 describe pacifiers attached to toys. Moreover, U.S. Pat. Nos. 5,658,314; 6,736,830; 5,606,871; 5,300,089; and 5,782,868 teach liquid-filled, frozen pacifiers. While these devices fulfill their respective objectives and requirements, the aforementioned patents do not provide visual stimulation or facilitate early childhood development and learning.

### SUMMARY OF THE INVENTION

The present invention features a liquid-fillable teething device fabricated in the shape of a letter of the alphabet, said liquid-fillable teething device having at least one non-smooth textured surface thereon and being fabricated from non-toxic materials and being sized and dimensioned to be comfortably inserted and partially retained within an infant's mouth for teething purposes. In some embodiments, the teething device further includes an object image representing said letter.

### BRIEF DESCRIPTION OF THE DRAWINGS

FIG. 1 illustrates exemplary liquid-fillable teething devices 10 fabricated in the shape of letters of the alphabet. Alternative block letter fonts are shown.

FIG. 2 depicts side views (FIGS. 2A-2C) and partial front views (FIG. 2D) of the liquid-fillable teething device. In some embodiments, the liquid-fillable teething device of the invention has one non-smooth textured surface 12 (FIGS. 2A and 2C). In other embodiments, liquid-fillable teething device 10 has two non-smooth textured surfaces (FIGS. 2B). Alternative textures are shown in FIG. 2D.

FIG. 3 depicts illustrative object images 16 representative of each letter of the alphabet.

### DETAILED DESCRIPTION OF THE INVENTION

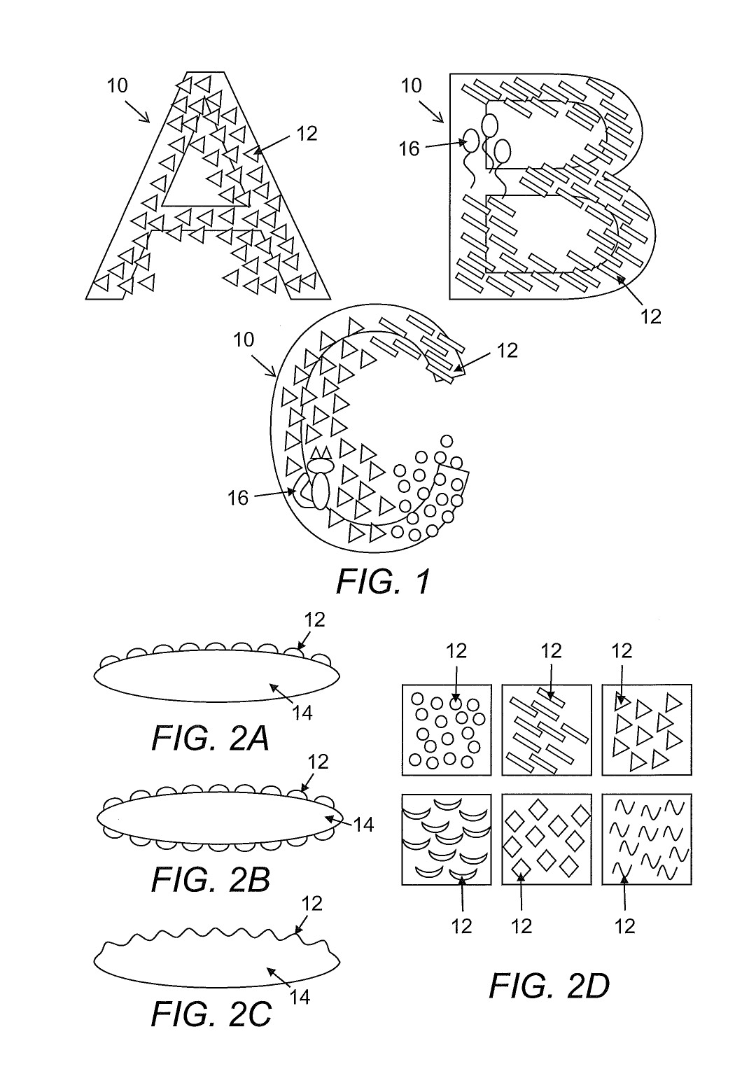

The present invention features a teething device for reducing soreness and inflammation, and thus discomfort, to an infant's sore gums as well as visual stimulation. As illustrated in FIG. 1, the instant teething device 10 is liquid-fillable, fabricated in the shape of a letter of the alphabet and has at least one non-smooth textured surface thereon 12. Teething device 10 is desirably of a size and dimension (e.g., approximately 4-5 inches in height and approximately 2 inches in width) to be comfortably inserted and partially retained within an infant's mouth for teething purposes. Letters can be in block font (FIG. 1) and can be upper or lower case.

The body of liquid-fillable teething device 10 is formed of a resilient, flexible, long-wearing, scuff-resistant, fluid impervious material, such as a food grade plastic, which maintains its resiliency over a temperature range of from about −20° F. to about 250° F. Examples of such plastics include, but are not limited to, polyethylene terephthalate, high density polyethylene, and low density polyethylene, which can be used alone, combined or modified according to conventional practices to improve the safety and use in the instant teething device. Desirably the material used in the fabrication of the liquid-fillable teething device 10 is non-allergenic and non-toxic, e.g., free of Bisphenol A and Phthalate. In addition, the material should be selected so that it can be easily cleaned and sanitized by any number of techniques. For example, it is desirable that the teething device can be sterilized in hot water, or with alcohol; manually washed with conventional soap and water; and/or easily cleaned automatically in a dishwasher.

To visually stimulate an infant and facilitate early learning, liquid-fillable teething device 10 is in the shape of a letter of the alphabet, which can be any color or combination of colors. Alternatively, liquid-fillable teething device 10 can be void of color (clear). Liquid-fillable teething device 10 can be produced in the shape of one or all 26 letters of the alphabet, wherein the colors of each letter are the same or different colors.

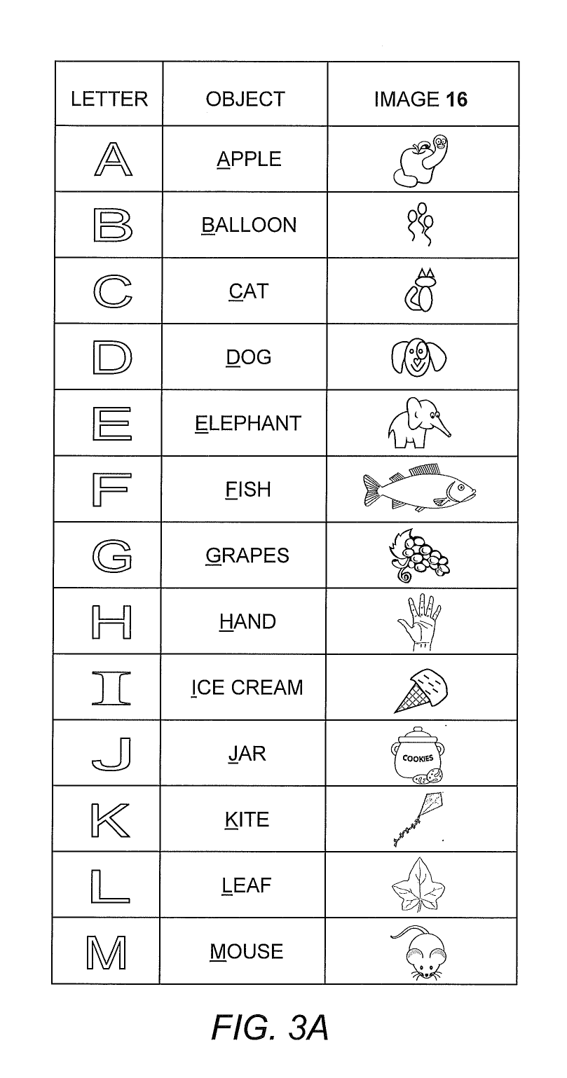

As shown in FIGS. 2A-2C, the body of liquid-fillable teething device 10 is hollow so as to form an interior cavity 14. The interior cavity 14 is filled with a liquid such as a gel, semi-fluid, or fluid material. Suitable liquids of use in the interior cavity 14 include, but are not limited to water (e.g., sterile or distilled water), food grade glycerin, a freezable or pliable gel, food grade propylene glycol or food grade ethylene glycol. An example of a pliable gel is a water soluble humectant (e.g., glycerin or ethylene glycol) entrapped within a polymeric matrix such as polymers, copolymers, or terpolymers containing acrylic acid or acrylamide monomer moieties (see U.S. Pat. No. 4,671,267). It is contemplated that liquid-fillable teething device 10 can be heated or cooled (e.g., frozen) in order to effect an appropriate thermal treatment. In this respect, the liquid selected can be dependent upon whether the liquid is to remain pliable over a relatively broad temperature range of from about −20° F. to 350° F. as is common with the pliable gels disclosed herein; or whether the liquid is capable of being frozen as with water. In a particular embodiment, the liquid used is pliable at room temperature.

The liquid can be injected or inserted into an opening to interior cavity 14 of liquid-fillable teething device 10 and sealed within the interior cavity 14 by inserting a plasticized plug in the opening or by sonic welding, heat fusing, or radio frequency sealing the opening. It is contemplated that when a plug is used, the plug can be permanently sealed once the cavity is filled with liquid or, alternatively, the plug can screw out and in or be otherwise removable so that the liquid can be replaced or exchanged. In this respect, liquid-fillable teething device 10 may already come pre-filled with some type of liquid from the manufacturer or alternatively be filled by the consumer.

As illustrated in FIGS. 1 and 2, liquid-fillable teething device 10 has at least one non-smooth textured surface 12 thereon. The texture can be in the form of bumps, ridges, lines, shapes, etc. (see FIG. 2D), or a combination of textures (see FIG. 1, letter “C”). In addition, the texture can be evenly or randomly distributed over the surface. It is contemplated that the textures can be molded into the surface of the liquid-fillable teething device 10 (see, e.g., FIG. 2C) or alternatively stamped or adhered as separate elements to the surface of the liquid-fillable teething device 10 (see, e.g., FIGS. 2A and 2B). The addition, the texture can be the same or a different color than the surface of liquid-fillable teething device 10. In some embodiments, the front or back surface (relative to the orientation of the letter) of liquid-fillable teething device 10 is textured (see FIGS. 1, 2A, and 2C). In other embodiments, both the front and back of the liquid-fillable teething device 10 will be textured (FIG. 2B).

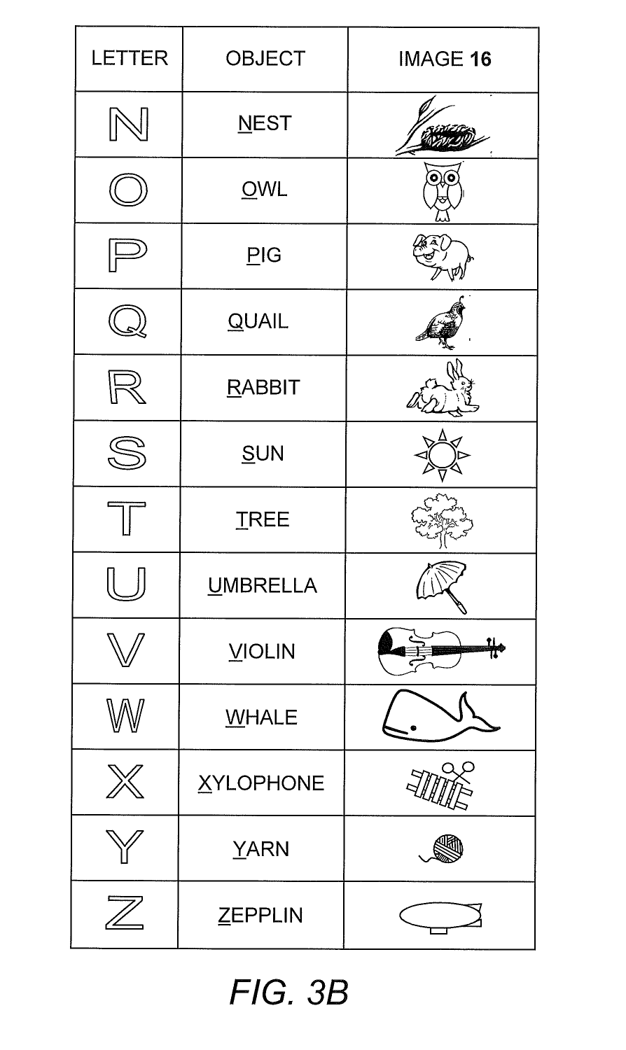

In particular embodiments of the present invention, the instant teething device 10 further includes object images 16 on the front and/or back of the liquid-fillable teething device 10 (FIG. 1). As depicted in FIG. 3, the object image 16 selected represents the letter of the alphabet. Any object image can be used so long as the first letter of said object image 16 is the same as the letter used in the fabrication of liquid-fillable teething device 10. The object image 16 can be in color, grayscale or black and white and can be painted, printed, adhered or embedded on the surface of the liquid-fillable teething device 10.

It is contemplated that the consumer can select one or multiple liquid-fillable teething devices 10 for an infant to use. The letters of the liquid-fillable teething devices 10 can be selected at random, selected to spell out a word (e.g., an animal, color, or occasion), or be selected to spell the infant's name.

In use, the teething device 10 can be heated or cooled to a desired temperature to effect an appropriate thermal treatment. The teething device 10 can be heated by immersion in boiling water, for example. In contrast, the teething device 10 can be cooled by placing the device in a conventional refrigerator or freezer. When the teething device 10 has been heated or cooled to the desired temperature, the teething device 10 is ready to be introduced into the mouth of an infant.

The instant teething device finds application in satisfying the teething needs of infants, while at the same time exercising, enhancing, and reinforcing the infant's grasping and fine motor skills, and providing a consistent visual stimulation and reinforcement of letter recognition. The instant teething device can be manufactured at a low cost with regard to both materials and labor, and which, accordingly, is then offered to the consuming public at a low price, thereby making such teething device construction economically available to the buying public.

What is claimed is:

1. A liquid-fillable teething device fabricated in the shape of a letter of the alphabet, said liquid-fillable teething device having at least one non-smooth textured surface thereon and being fabricated from non-toxic materials and being sized and dimensioned to be comfortably inserted and partially retained within an infant's mouth for teething purposes.

2. The teething device of claim 1, further comprising an object image representing said letter.
